(19) United States
(12) Patent Application Publication
(10) Pub. No.: US 2020/0388965 A1
(43) Pub. Date: Dec. 10, 2020

(54) Contact Terminal

(71) Applicant: Tyco Electronics UK Ltd., Swindon (GB)

(72) Inventor: John Marsh, London (GB)

(73) Assignee: Tyco Electronics UK Ltd., Swindon (GB)

(21) Appl. No.: 16/890,556

(22) Filed: Jun. 2, 2020

(30) Foreign Application Priority Data
Jun. 5, 2019 (EP) 19178451.1

(51) Int. Cl. H01R 13/631; H01R 13/11; H01R 13/502; H01R 4/48; H01R 13/187

(52) U.S. Cl. CPC H01R 13/6315; H01R 13/113; H01R 13/187; H01R 4/4818; H01R 13/502

(57) ABSTRACT

A contact terminal for connecting a pair of contact tabs includes a first tab reception volume, a second tab reception volume, a holder, and a contact spring attached to the holder. Each of the first tab reception volume and the second tab reception volume receive one of the pair of tabs in an insertion direction. The contact spring extends continuously from the first tab reception volume to the second tab reception volume and at least partially limits the first tab reception volume and the second tab reception volume on a side.

### CROSS-REFERENCE TO RELATED APPLICATION

This application claims the benefit of the filing date under 35 U.S.C. § 119(a)-(d) of European Patent Application No. 19178451.1, filed on Jun. 5, 2019.

### FIELD OF THE INVENTION

The present invention relates to a contact terminal and, more particularly, to a contact terminal for connecting at least two contact tabs.

### BACKGROUND

A contact terminal for connecting at least two contact tabs has a first tab reception volume and a second tab reception volume, each being configured to receive one of the two contact tabs in a respective insertion direction. The contact terminal has at least one contact spring, which extends continuously from the first to the second tab reception volume at one side thereof, the at least one contact spring being attached to a holder.

Such contact terminals are often used for connecting contact tabs of electrical connectors. In particular, contact tabs having the capability to carry high electrical currents are useful in a variety of applications. In automobiles, for example, they may be used in a power distribution center to carry a current between components. However, particularly in automobiles, the contact terminal as well as the contact tabs are subjected to stress such as vibrations, which may cause a misalignment between the tabs. Furthermore, the number of contact points may vary depending on the application. Thus, for each application, a specific pre-manufactured contact terminal is necessary. The excessive stock of different contact terminals causes an increase of production and storage costs.

### SUMMARY

A contact terminal for connecting a pair of contact tabs includes a first tab reception volume, a second tab reception volume, a holder, and a contact spring attached to the holder. Each of the first tab reception volume and the second tab reception volume receive one of the pair of tabs in an insertion direction. The contact spring extends continuously from the first tab reception volume to the second tab reception volume and at least partially limits the first tab reception volume and the second tab reception volume on a side.

### BRIEF DESCRIPTION OF THE DRAWINGS

The invention will now be described by way of example with reference to the accompanying Figure, of which:

FIG. 1 is a perspective view of a contact terminal according to a first embodiment;

FIG. 2 is a sectional side view of the contact terminal of FIG. 1;

FIG. 3 is a perspective view of a contact terminal according to a second embodiment;

FIG. 4 is a sectional side view of the contact terminal of FIG. 3;

FIG. 5 is a perspective view of a contact spring according to a first embodiment;

FIG. 6 is a side view of the contact spring of FIG. 5;

FIG. 7 is a perspective view of a contact spring according to a second embodiment;

FIG. 8 is a side view of the contact spring of FIG. 7;

FIG. 9 is a perspective view of a contact spring according to a third embodiment; and

FIG. 10 is a side view of the contact spring of FIG. 9.

### DETAILED DESCRIPTION OF THE EMBODIMENT(S)

In the following, the contact terminal according to the invention is explained in greater detail with reference to the accompanying drawings, in which exemplary embodiments are shown. In the figures, the same reference numerals are used for elements, which correspond to one another in terms of their function and/or structure.

According to the description of the various aspects and embodiments, elements shown in the drawings can be omitted if the technical effects of those elements are not needed for a particular application, and vice versa: i.e. elements that are not shown or described with reference to the figures but are described above can be added if the technical effect of those particular elements is advantageous in a specific application.

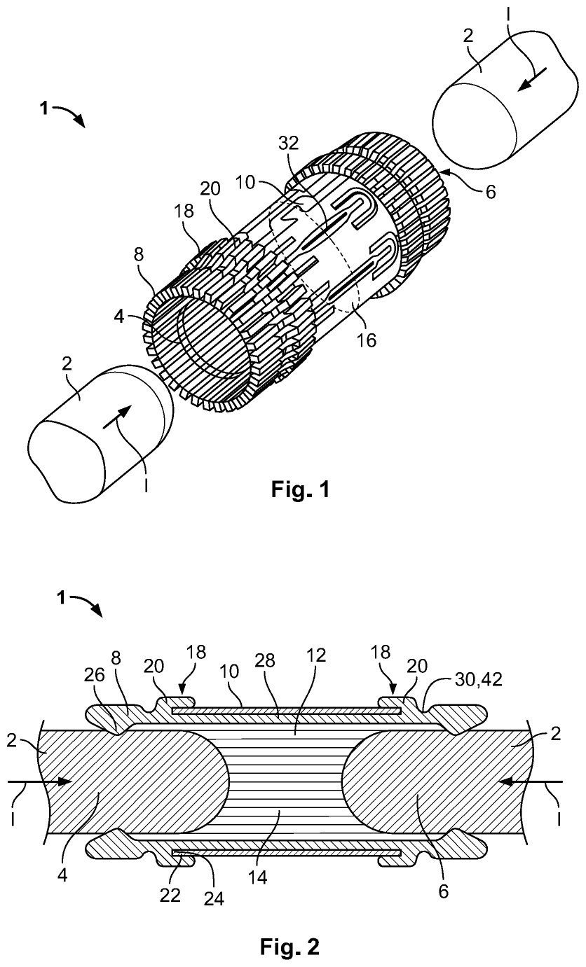

A first embodiment of a contact terminal 1 according to the invention is described with reference to FIGS. 1 and 2. The contact terminal 1 is adapted to connect at least two contact tabs 2 and comprises a first tab reception volume 4 and a second tab reception volume 6, each being configured to receive one of the two contact tabs 2 in a respective insertion direction I. The insertion direction I of each contact tab 2 may be essentially antiparallel to the other.

The contact terminal 1 further comprises at least one contact spring 8, which extends continuously from the first tab reception volume 4 to the second tab reception volume 6 at one side thereof. The at least one contact spring 8 may be configured to be deflected resiliently in a direction perpendicular to the respective insertion direction I and away from the respective first and second tab reception volume 4,6. Therefore, the at least one contact spring 8 may be biased against a surface of the contact tabs 2 and be deflected resiliently upon insertion of the respective contact tabs 2, optimizing the mating force of the contact terminal 1.

The at least one contact spring 8 is attached to a holder 10, as shown in FIGS. 1 and 2. The at least one contact spring 8 and the holder 10 may be separate parts in an embodiment, whereby the at least one contact spring 8 is adapted to be mounted to the holder 10.

In order to provide a contact terminal 1 that can be easily adjusted to different applications and allows for a secure and stable connection even when subjected to stress, such as vibrations, the at least one contact spring 8 limits the first and second tab reception volume 4, 6 on one side at least partially. In an embodiment, each contact spring 8 may limit the first and second tab reception volume 4, 6 at least partially only on one side.

As shown in FIG. 2, the first tab reception volume 4 and the second tab reception volume 6 may be contiguous to form a common receptacle 12. The first and second tab reception volumes 4, 6 may be opened to opposing sides so that the contact tabs 2 may be inserted in their respective insertion directions I, the insertion directions I opposing one another. The common receptacle 12 may comprise a transition volume 14 arranged between the first and second tab reception volume 4, 6 and preventing the contact tabs 2 from abutting each other.

The holder 10 may be arranged in the transition volume 14; the holder 10 may overlap with the transition volume 14 in a direction perpendicular to the insertion direction I. The holder 10 may also at least partially overlap with the first tab reception volume 4 and/or the second tab reception volume 6 in a direction perpendicular to the respective insertion direction I, for at least partially receiving the respective contact tabs 2.

The holder 10 may extend at least partially around the common receptacle 12 and/or at least partially around the first and second tab reception volumes 4, 6. The holder 10 may define a cross section, particularly a cross section in a plane perpendicular to the insertion direction I, of at least one of the first and second tab reception volumes 4, 6. Thus, the overall shape of the first and second tab reception volumes 4, 6 may be defined by the holder 10. The holder 10 may comprise a shape complementary to the contact tabs. For example, if the contact tabs 2 are oblong, the holder 10 may have a shape extending around an oblong cross section in a plane perpendicular to the respective insertion direction I.

In the embodiment shown in FIGS. 1 and 2, the contact tabs 2 are cylindrical. Thus, it is favorable to have complementary formed tab reception volumes 4, 6. The holder 10 may have a shape extending around a circular cross section in a plane perpendicular to the respective insertion direction I. The overall shape of the first and second tab reception volumes' 4, 6 cross section 16 may be defined by the holder 10 that at least partially extends around the first and second tab reception volumes 4, 6.

The holder 10 and the at least one contact spring 8 may comprise a snap-on assembly 18, as shown in FIGS. 1 and 2, for securely mounting the at least one contact spring 8 to the holder 10. With the snap-on assembly 18, an easy and quick mounting and/or dismounting of the at least one contact spring 8 may be achieved without the need of any further mounting components. Alternatively to the snap-on assembly 18, a sliding mechanism via rails or mounting with an interference fit may be provided to mount the at least one contact spring 8 to the holder 10.

In an embodiment, the holder 10 is arranged beyond the at least one contact spring 8 with respect to the first and second tab reception volumes 4, 6 in a direction perpendicular to the respective insertion direction. The contact spring 8 may be arranged between the holder 10 and the first tab reception volume 4 and second tab reception volume 6 in a direction perpendicular to the respective insertion direction I. In another embodiment, the at least one contact spring 8 may be arranged beyond the holder 10 with respect to the first and second tab reception volume 4, 6 in a direction perpendicular to the respective insertion direction I, i.e. the holder 10 may be arranged between the at least one contact spring 8 and the first and second tab reception volume 4, 6.

The at least one contact spring 8 has a snapping structure 20 with a pair of snapping slots 22 adapted to be snapped onto edges 24 of the holder 10. The snapping slots 22 may be arranged opposite to one another in the insertion direction I. Therefore, the at least one contact spring 8 can be securely mounted on the holder 10. In other embodiments, any other mechanism for mounting, particularly removably mounting the at least one contact spring 8, is imaginable within the scope of the invention, such as a sliding engagement and/or mounting by an interference fit.

Multiple contact springs 8 may be mounted to the holder 10, wherein the distance between the contact springs 8 can be set according to the application requirements. For example, the contact springs 8 may be stacked to a tight package, increasing the number of contact points and consequently the capability of carrying higher electrical currents. The at least two contact springs 8 may be arranged upright and side by side, as a stacked package. Therefore, the at least two contact springs 8 may contact the contact tabs 2 from the same side. Multiple contact springs 8 may be arranged side by side so that the package of contact springs 8 may fully limit the first tab reception volume 4 and the second tab reception volume 6 from one side. Alternatively or additionally, at least two contact springs 8 may be arranged on different, particularly opposing sides of the first and second tab reception volumes 4, 6. When arranged on opposing sides, the at least two contact springs 8 may be arranged opposite to one another or in a staggered formation relative to one another. A row of contact springs 8 can be arranged on opposing sides of the first and second tab reception volumes 4, 6, forming a mouth for receiving the contact tabs 2.

When mounting several contact springs 8 to the holder 10, each contact spring 8 may engage a separate snapping structure 20 being arranged relative to each other at predetermined positions. The at least two contact springs 8 may be adapted to be independently deflectable from one another, so that each contact spring 8 can compensate for tolerances without influencing the other. In particular, micro tolerances such as irregularities of the surface of the contact tab 2 may be compensated by the contact springs 8 without influencing each other. This may further ensure the mating force and secure connection between the contact tab 8 and the contact terminal 1.

The at least one contact spring 8 may extend in a direction opposite the respective insertion direction I beyond the holder 10 and comprise a contact section 26 protruding from a main body 28, as shown in FIG. 2. The contact section 26 in the shown embodiment protrudes perpendicular to the respective insertion direction I, towards the respective tab reception volume 4, 6. The contact section 26 may be distanced from the holder 10 in a direction opposite to the respective insertion direction I. In the shown embodiment, the at least one contact spring 8 has a deflection section 30 distanced away from the holder 10 in a direction opposite the respective insertion direction I. Therefore, the deflection of the at least one contact spring 8 may not noticeably be transferred to the holder 10.

As the at least one contact spring 8 is adapted for electrically connecting the two contact tabs 2, the at least one contact spring 8 may be optimized by forming the at least one contact spring 8 with copper or a copper alloy. The at least one contact spring 8 may be formed by at least one of stamping, bending and wire extrusion.

In order to further increase the flexibility of the contact terminal 1 and optimize the contact force and stabilize the connection under conditions of misalignment and movement, the holder 10 may comprise at least one tolerance adjustment spring 32 shown in FIG. 1. The tolerance adjustment spring 32 may be adapted to compensate for higher tolerances, such as contact tab 2 tolerances and/or contact tab 2 misalignment, while the at least one contact spring 8 may be adapted to compensate for smaller tolerances, such as variations on the surface of the contact tabs 2. Therefore, each spring, i.e. the contact spring 8 and the tolerance adjustment spring 32, may be optimized for their respective task. For this the at least one tolerance adjustment spring 32 may have at least one of a lower spring rate and a larger spring stroke with respect to the at least one contact spring 8.

The holder 10 may be optimized for mechanical stability and may therefore be formed by steel, e.g. stainless steel.

In order to provide a high current capability, the number of contact springs 8 mounted to the holder 10 can be increased, whereby each contact spring 8 may be independent from the other.

In the embodiment shown in FIGS. 1 and 2, a package of contact springs 8 is mounted to the holder 10, whereby the contact springs 8 are each arranged along the inner circumference of the holder 10. Therefore, the contact tabs 2 may each be contacted on several sections along their circumference. Depending on the desired amount of contact points in the application, the contact springs 8 may be arranged distanced from one another along the circumference or adjoining to each other.

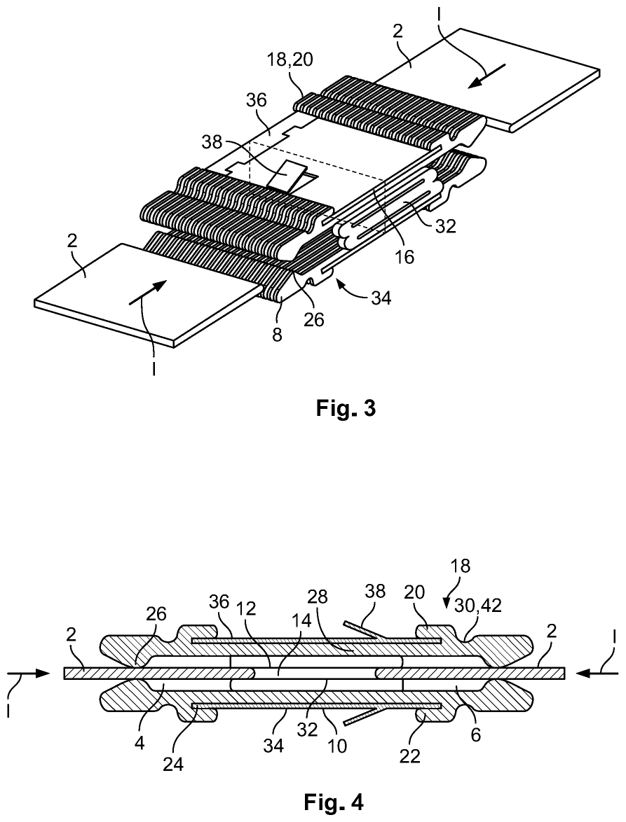

A contact terminal 1 according to another embodiment, as shown in FIGS. 3 and 4, includes contact springs 8 that are identically structured to the contact springs 8 in the first embodiment. The holder 10, however, defines a different cross section 16, as the holder 10 in the embodiment of FIGS. 3 and 4 extends around an essentially rectangular cross section 16.

The holder 10, as shown in FIGS. 3 and 4, has a base 34 and a top 36, whereby the base 34 and the top 36 are connected to each other by tolerance adjustment springs 32, which are arranged to be resiliently flexed in a direction perpendicular to the respective insertion direction I. In this exemplary second embodiment, stacks of contact springs 8 are arranged on the holder 10, each limiting the first and second tab reception volumes 4, 6 on opposing sides, perpendicular to the respective insertion direction I. Therefore, the contact tabs 2 may be contacted at multiple areas on a top and bottom surface, increasing the amount of contact points and thereby the capability of transmitting high currents. However, since each contact spring 8 only limits the first and second tab reception volumes 4, 6 at least partially on one side perpendicular to the respective insertion direction I, it is also possible to arrange a stack of contact springs 8 on one side only opposing an essentially planar counter surface. A resulting single sided contact terminal 1 would reduce the size and manufacturing costs of the contact terminal 1. Furthermore, the essentially planar counter surface may further increase the stability against vibrations.

The holder 10 may further comprise a locking latch 38, as shown in FIGS. 3 and 4, for locking the contact terminal 1 in a housing (not shown). The locking latch 38 may press against a surface of the housing and may thus exert a biasing force on the tolerance adjustment springs 32 when the contact terminal 1 is mounted in the housing. The locking latch 38 may be stamped out from the top 36 and/or base 34 of the holder 10.

The embodiments shown in FIGS. 1-4 may be comprised in a set, whereby the contact springs 8 of each contact terminal 1 are structured identically and the holders 10 are different in that they define different cross sections 16 in a plane perpendicular to the respective insertion direction I. The set may also comprise holders defining cross sections 16 of different sizes. Therefore, with the inventive contact terminal 1, it is possible to have various shapes and sizes that can be scaled with the structurally identically contact springs 8. The contact terminal 1 may be adapted for cylindrical, rectangular, single-sided, double-sided, or any other shape of contact tabs 2.

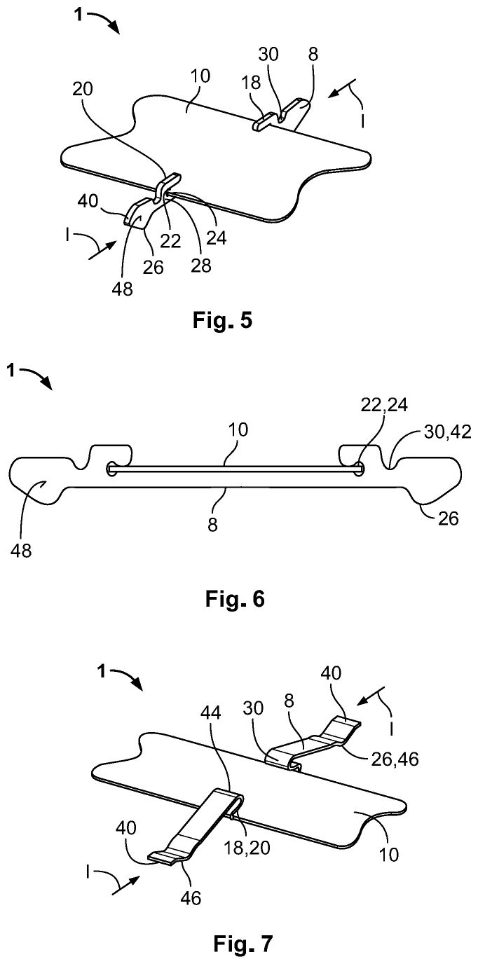

In the following, different embodiments of the contact spring 8 are described with reference to FIGS. 5-10.

In FIGS. 5 and 6 a first embodiment of the contact spring 8 is shown, which is also depicted in the embodiments of the contact terminal 1 in FIGS. 1-4. In the first embodiment, the contact spring 8 is a stamped part, whereby the contact sections 26 are formed on each free end 40 of the contact spring 8. The snapping slots 22 of the snapping structure 20 snap onto the edges 24 of the holder 10, forming a positive fit in the respective insertion direction I. The mounted contact spring 8 may be adapted to slide in a direction perpendicular to the respective insertion direction I relative to the holder 10 for positioning the contact spring 8. However, a stop device may also be featured to secure the relative position of the contact spring 8.

In FIGS. 5 and 6, between contact section 26 and snapping structure 20, the contact spring 8 is provided with a deflection section 30 formed by a notch 42 so that the material thickness at the deflection section 30 is lower than its immediate surroundings. Therefore, the contact spring 8, in particular the contact section 26, may pivot around an axis of rotation arranged perpendicular to the respective insertion direction I in the deflection section 30.

The contact spring 8 being a stamped part is advantageous for a large scale and cost effective production. Multiple contact springs 8 can be arranged face to face adjacent to one another in the respective insertion direction I on the holder 10. Therefore, a space efficient stacking of multiple contact springs 8 may be achieved allowing for a larger number of stackable contact springs 8, and consequently contact points.

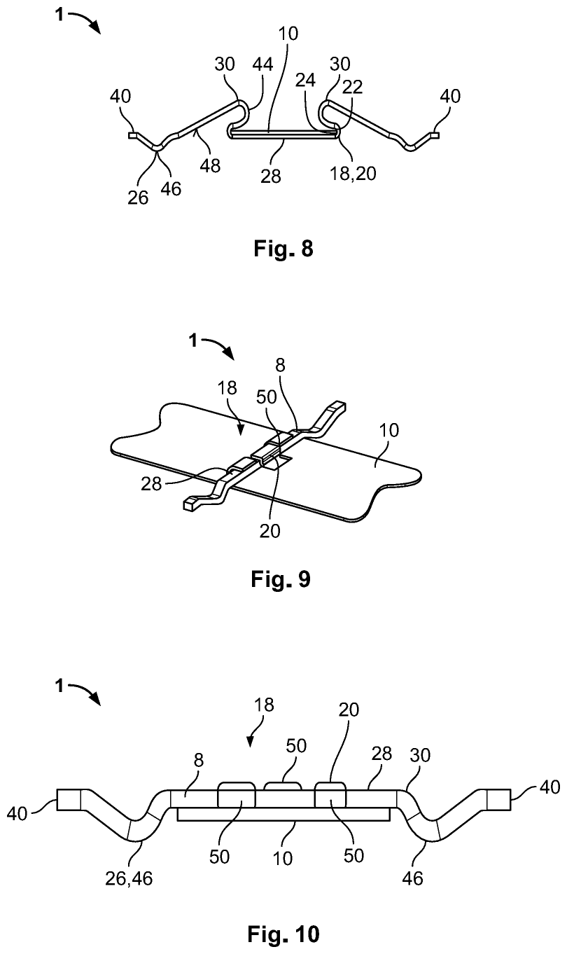

A second embodiment of the contact spring 8 is elucidated with reference to FIGS. 7 and 8, depicting a schematic perspective view and a side view of the contact spring 8, respectively. In the second embodiment, the contact spring 8 may be formed by stamping and subsequently bending the stamped contact spring 8 into shape. The contact spring 8 may be a stamped copper strip that is formed in such a way that the main body 28 has the snapping structure 20 with snapping slots 22 that engage the edges 24 of the holder 10. The main body 28 is bent around essentially 180° and further extends towards the respective tab reception volume 4, 6 forming an arch 44 that serves as the deflection section 30. The contact section 26 is formed by a convex bulge 46 of the contact spring 8 that protrudes from the main body 28 towards the respective tab reception volume 4, 6. The free ends 40 of the contact spring 8 are bent away from the respective tab reception volumes 4, 6.

In the embodiment shown in FIGS. 7 and 8, a face side 48 of the contact spring 8 faces the tab reception volumes 4, 6 so that multiple contact springs 8 can be arranged next to one another side by side. Therefore, a larger surface may be contacted by the contact section 26 of a contact spring 8 further stabilizing the contact force. A further advantageous aspect of the second embodiment is that the contact section 26 is formed on the face side 48 of the contact spring 8, so that a contact between the stamped outline and the surface of the contact tabs 2 may be prevented. During the stamping process, burs may be formed on the outline, which could scrape the surface of the contact tabs 2 increasing the risk of fretting corrosion.

In the third embodiment of the contact spring 8, shown in FIGS. 9 and 10, the contact spring 8 may be formed by wire extrusion. The extruded beam may be bent in shape by forming a convex bulge 46 that protrudes towards the respective tab reception volume 4, 6 in a direction perpendicular to the respective insertion direction I. In the third embodiment, the snapping structure 20 is formed by latches 50 of the holder 10 that are adapted to be bent around the contact spring 8. A total of three latches 50 may be provided arranged in an alternating formation on either side of the contact spring 8. By bending the latches 50 around the contact spring 8, in particular the main body 28 of the contact spring 8, the contact spring 8 is securely fastened to the holder 10. By providing the holder 10 with the snapping structure 20, the relative position of the contact spring 8 on the holder 10 may be predetermined, increasing the ease of use. Furthermore, in the third embodiment, the holder 10 may be arranged between the at least one contact spring 8 and the first and second tab reception volumes 4, 6 in a direction essentially perpendicular to the respective insertion direction I.

With having the at least one contact spring 8 limiting the first and second tab reception volume 4, 6 only on one side at least partially, the at least one contact spring 8 may be resiliently deflected independently from the opposing side increasing the stability of the contact terminal 8 against vibrations. Furthermore, the number of contact springs 8 and their respective positions can be adjusted depending on the application requirements. As each contact spring 8 only limits the first and second tab reception volume 4, 6 at least partially on one side, each contact spring 8 does not take up a lot of space and can be arranged easily at their respective positions.

In an embodiment, a set includes a plurality of contact terminals 1 separate from one another. The contact spring 8 of each of the contact terminals 1 is identically structured and the holder 10 of each of the contact terminals 1 is differently structured with different cross-sections of at least one of the first tab reception volume 4 and the second tab reception volume 6.

What is claimed is:

1. A contact terminal for connecting a pair of contact tabs, comprising:
a first tab reception volume;
a second tab reception volume, each of the first tab reception volume and the second tab reception volume receive one of the pair of tabs in an insertion direction;
a holder; and
a contact spring attached to the holder, the contact spring extending continuously from the first tab reception volume to the second tab reception volume and at least partially limiting the first tab reception volume and the second tab reception volume on a side.

2. The contact terminal of claim 1, wherein the first tab reception volume and the second tab reception volume are contiguous and form a common receptacle.

3. The contact terminal of claim 1, wherein the holder is arranged beyond the contact spring with respect to the first tab reception volume and the second tab reception volume.

4. The contact terminal of claim 1, wherein the holder and the contact spring are separate parts.

5. The contact terminal of claim 1, wherein the contact spring has a contact section contacting one of the contact tabs.

6. The contact terminal of claim 5, wherein the contact section protrudes from a main body of the contact spring toward one of the first tab reception volume and the second tab reception volume.

7. The contact terminal of claim 1, wherein the contact spring is one of a plurality of contact springs.

8. The contact terminal of claim 7, wherein the plurality of contact springs are independently deflectable from each other.

9. The contact terminal of claim 7, wherein the plurality of contact springs are mounted on a side of each of the first tab reception volume and the second tab reception volume opposing a counter surface.

10. The contact terminal of claim 7, wherein the plurality of contact springs are mounted on opposing sides of the first tab reception volume and the second tab reception volume.

11. The contact terminal of claim 2, wherein the holder extends at least partially around the common receptacle.

12. The contact terminal of claim 1, wherein the holder has a tolerance adjustment spring.

13. The contact terminal of claim 12, wherein the tolerance adjustment spring has at least one of a lower spring rate and a larger spring stroke than the contact spring.

14. The contact terminal of claim 12, wherein the holder has a base and a top, the tolerance adjustment spring connects the base and the top.

15. The contact terminal of claim 12, wherein the contact spring is arranged parallel to the tolerance adjustment spring.

16. The contact terminal of claim 6, wherein the holder has an edge and the contact spring has a snapping structure with a snapping slot, the snapping slot is snapped onto the edge.

17. The contact terminal of claim 16, wherein the contact spring has a deflection section between the contact section and the snapping structure.

18. A set, comprising:
a plurality of contact terminals separate from one another, each of the contact terminals having a first tab reception volume, a second tab reception volume, a holder, and a contact spring attached to the holder, each of the first tab reception volume and the second tab reception volume receive one of a pair of tabs in an insertion direction, the contact spring extending continuously from the first tab reception volume to the second tab reception volume and at least partially limiting the first tab reception volume and the second tab reception volume on a side, the contact spring of each of the contact terminals is identically structured and the holder of each of the contact terminals is differently structured with different cross-sections of at least one of the first tab reception volume and the second tab reception volume.
